(19) United States
(12) Patent Application Publication
(10) Pub. No.: US 2013/0319161 A1
(43) Pub. Date: Dec. 5, 2013

(54) SELF-LOOSENING CAPSULE

(71) Applicants: William D. Cymbal, Saginaw, MI (US); Melvin L. Tinnin, Clio, MI (US); Richard K. Riefe, Saginaw, MI (US)

(72) Inventors: William D. Cymbal, Saginaw, MI (US); Melvin L. Tinnin, Clio, MI (US); Richard K. Riefe, Saginaw, MI (US)

(21) Appl. No.: 13/671,798

(22) Filed: Nov. 8, 2012

Related U.S. Application Data
(60) Provisional application No. 61/652,583, filed on May 29, 2012.

(51) Int. Cl. B62D 1/19

(52) U.S. Cl. CPC B62D 1/195
USPC 74/492

(57) ABSTRACT

A steering column having a mounting bracket and a self-loosening capsule assembly configured for attachment to an adjacent vehicle component is provided. The mounting bracket includes an installation slot, a flange extending within the installation slot and a bracket keying mechanism positioned at a periphery of the installation slot. The self-loosening capsule assembly is received in the installation slot, and includes a capsule and capsule nut. The capsule includes a head and a body extending from the head, the body having a threaded outer surface, the head having a larger outer diameter than the body. The capsule nut includes a threaded inner surface for threaded coupling to the capsule and is movable so as to apply a first clamping force to the flange of the mounting bracket between the head and the capsule nut and a keying mechanism configured to interface with the bracket keying mechanism.

### CROSS-REFERENCES TO RELATED APPLICATIONS

This patent application claims priority to U.S. Provisional Patent Application Ser. No. 61/652,583, filed May 29, 2012, which is incorporated herein by reference in its entirety.

### BACKGROUND OF THE INVENTION

The following description relates to a break away element in an energy absorbing steering column, and in particular, a self-loosening capsule in an energy absorbing steering column.

Energy absorbing steering columns typically require a break away mechanism to allow for relative movement between the steering column and vehicle in the event of a crash. Currently, a die cast capsule may be attached to the steering column mounting bracket by injecting plastic between ribs of the capsule and the mounting bracket. The mounting bracket is secured to an adjacent vehicle component to secure the mounting bracket and steering column to the vehicle.

However, the plastic portion between the capsule and the mounting bracket can be a “soft” element when evaluating natural frequency and stiffness. As such, because the energy may be absorbed by the plastic, a higher load may be required for the capsule to break away from the mounting bracket. In some cases, the load required for breaking away may be unsuitably high due to the plastic portion.

Accordingly, it is desirable to provide a capsule that may be attached to the mounting bracket without injecting plastic to provide improved frequency and stiffness characteristics.

### SUMMARY OF THE INVENTION

According to an exemplary embodiment of the present invention, there is provided a self-loosening capsule assembly for a steering column, the self-loosening capsule assembly having a capsule configured for installation in a mounting bracket of the steering column, the capsule including a threaded outer surface, and a capsule nut including a threaded inner surface for threaded coupling to the capsule and movable so as to apply a first clamping force to the mounting bracket, the capsule nut comprising a keying mechanism configured to engage a corresponding keying mechanism on the mounting bracket.

According to another exemplary embodiment of the present invention, there is provided a steering column having a mounting bracket and a self-loosening capsule assembly, the mounting bracket configured to be secured to an adjacent vehicle component and having an installation slot, a flange extending within the installation slot and a bracket keying mechanism positioned at a periphery of the installation slot. The self-loosening capsule assembly includes a capsule having a head and a body extending from the head, the body having a threaded outer surface, the head having a larger outer diameter than the body, and a capsule nut having a threaded inner surface for threaded coupling to the capsule and movable so as to apply a first clamping force to the flange of the mounting bracket between the head and the capsule nut and a keying mechanism configured to interface with the bracket keying mechanism of the mounting bracket.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross section of a self-loosing capsule assembly installed in a mounting bracket according to an exemplary embodiment of the present invention;

FIG. 2 is a top view of a self-loosening capsule assembly installed in a mounting bracket according to an exemplary embodiment of the present invention;

FIG. 3 is a cross section of a self-loosening capsule assembly installed in a mounting bracket and fastened to an adjacent vehicle component according to an exemplary embodiment of the present invention;

FIG. 4 is top view of a self-loosening capsule assembly installed in a mounting bracket during an impact according to an exemplary embodiment of the present invention; and

FIG. 5 is a cross section of a self-loosening capsule assembly installed in a mounting bracket and fastened to an adjacent vehicle component during an impact according to an exemplary embodiment of the present invention.

### DETAILED DESCRIPTION

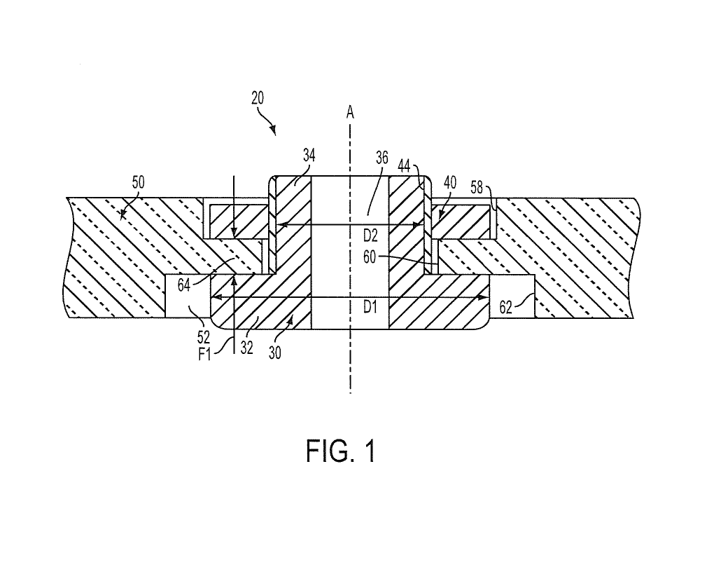

Referring now to the Figures, where the invention will be described with reference to specific embodiments, without limiting same, FIG. 1 is a cross section of a self-loosening capsule assembly 20 comprising a capsule 30 and capsule nut 40. The self-loosening capsule assembly 20 is installed in a mounting bracket 50 of a steering column (not shown). The mounting bracket 50 is configured to mount the steering column in a vehicle.

In an exemplary embodiment, the capsule 30 is round in shape and includes a head 32 and body 34. The head 32 has a first outer diameter D1 and the body has a second outer diameter D2. The first outer diameter is greater than the second outer diameter. The head 32 is generally disk shaped.

The body 34 extends from the head 32. In an exemplary embodiment, the body 34 extends along a first axis ‘A’. An outer surface of the body 34 includes an external thread. A central bore 36 extends through the head 32 and body 34 along the axis ‘A’. The central bore 36 is internally threaded and is configured to receive a threaded fastener.

The capsule nut 40 is generally annular in shape. The capsule nut 40 includes a central opening 44 configured to received the body 34 of the capsule 30 therein. In an exemplary embodiment, the central opening 44 has an internal thread so that the capsule nut 40 may be threadably coupled with the external thread of the body portion 34.

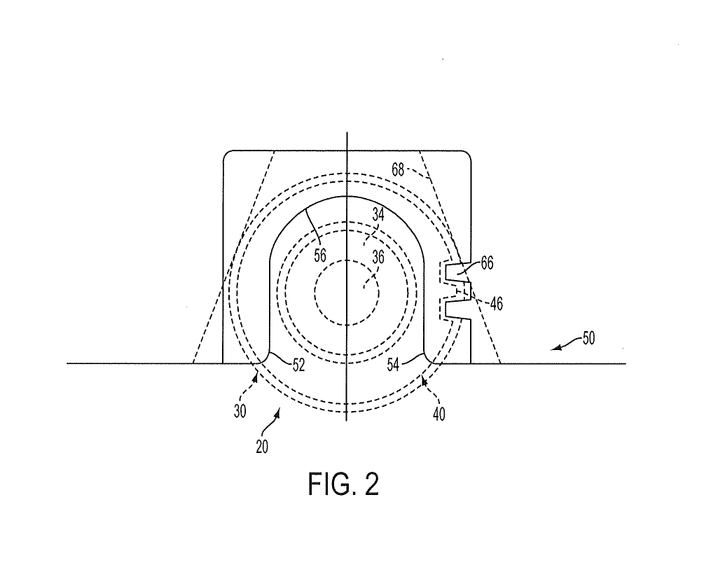

FIG. 2 is a top view of the self-loosening capsule assembly 20 installed in the mounting bracket 50. With reference to FIG. 2, the capsule nut 40 also includes a keying mechanism 46. In an exemplary embodiment, the keying mechanism is formed as at least one radial projection formed along an outer periphery of the capsule 40 with a recess positioned on each side of the projection. It is understood that the present invention is not limited to this configuration and other keying mechanisms may be used. For example, a single projection or multiple projections may be used.

Referring to FIGS. 1 and 2, the mounting bracket 50 is configured to be secured to an adjacent vehicle component to mount the steering column in the vehicle. The mounting bracket 50 includes at least one mounting portion having an installation slot 52 to receive the self-loosening capsule assembly 20. The installation slot 52 includes an open end 54 and a closed end 56. The installation slot further includes a first portion 58 configured to receive the capsule nut 40 and a portion of the body 34, a second portion 60 configured to receive another portion of the body 34, and a third portion 62 configured to receive the head 32 of the capsule 30.

The second portion 60 of the installation slot 52 has a smaller width than the first portion 58 and third portion 62. The second portion 60 is bounded by a flange 64 formed within the installation slot 52. The flange 64 projects inwardly within the installation slot 52 and separates the first portion 58 from the third portion 62.

Referring again to FIG. 2, the mounting bracket 50 further includes a bracket keying mechanism 66 formed in the first portion 58. The bracket keying mechanism 66 corresponds to the keying mechanism 46 of the capsule nut 40. In an exemplary embodiment, the bracket keying mechanism 66 includes two projections and a recess formed between the projections. The recess is configured to receive the projection of the keying mechanism 46 of the capsule nut 40 while the projections are configured to project into respective recesses of the keying mechanism 46 of the capsule nut 40. Thus, the bracket keying mechanism 66 is interfaced with the keying mechanism 46 of the capsule nut 40. A torque may be applied to the capsule nut 40 due to the interface between the respective keying mechanisms 46, 66 if the mounting bracket 50 is moved due to, for example, an impact force during a vehicle crash as described further below. It is understood that the present invention is not limited to the bracket keying mechanism structure described in the exemplary embodiment above, and that other keying mechanism are envisioned that may apply a torque to the capsule nut 40 in response to movement of the mounting bracket 50.

The mounting bracket 50 further includes a wedge 68 formed in the third portion 62 of the installation slot 52. In an exemplary embodiment, the wedge 68 is formed so that a width of the third portion 62 decreases along a direction moving from the open end 54 to the closed end 56. Before final installation and securing the self-loosening capsule assembly 20 in the mounting bracket 50, the head 32 of the capsule 30 is moved into contact with the wedge 68 to minimize or eliminate lateral and vertical clearances between the self-loosening capsule assembly 20 and the mounting bracket 50.

To install the self-loosening capsule assembly 20 on the mounting bracket 50, the capsule nut 40 and capsule 30 are positioned in the installation slot 52 of the mounting bracket 50. As noted above, in an exemplary embodiment, the capsule nut 40 is internally threaded so as to be threadably coupled to the body 34 of the capsule 30 via an external thread of the body 34. The capsule 40 is rotated about the body 34 so that the capsule nut 40 moves toward the flange 64. The head 32 of the capsule 30 is also moved toward the flange 64. Continued rotation of the capsule nut 40 on the body 34 of the capsule 30 causes the capsule nut 40 and head 32 to apply a first clamping force ‘F1’ on the flange 64 as shown in FIG. 1.

Before the capsule 30 and capsule nut 40 are secured into place on the mounting bracket, the capsule 30 may be moved within the installation slot 52 so that the head 32 comes into contact with the wedge 68 to take up any clearances. The capsule 30 and capsule nut 40 may then be clamped into position within the installation slot 52 such that the first clamping force ‘F1’ is applied to the flange 64 and the capsule 30 and capsule nut 40 are held in position on the mounting bracket 50.

In addition, the keying mechanism 46 of the capsule nut 40 is interfaced with the bracket keying mechanism 66 such that the projections of the bracket keying mechanism 66 are received in respective recesses of the keying mechanism 46 of the capsule nut 40, and the projection of the keying mechanism 46 of the capsule nut 40 is received within the recess of the bracket keying mechanism 66. Further, when installed, a top surface of the capsule 40 is positioned below a top surface of the mounting bracket 50. That is, a top surface of the capsule nut 40 does not extend outwardly from the first portion 58 in the direction of axis ‘A’. In this condition, the self-loosening capsule assembly 20 is installed on the mounting bracket 50 and may delivered to an assembly plant where the steering column may be installed in a vehicle.

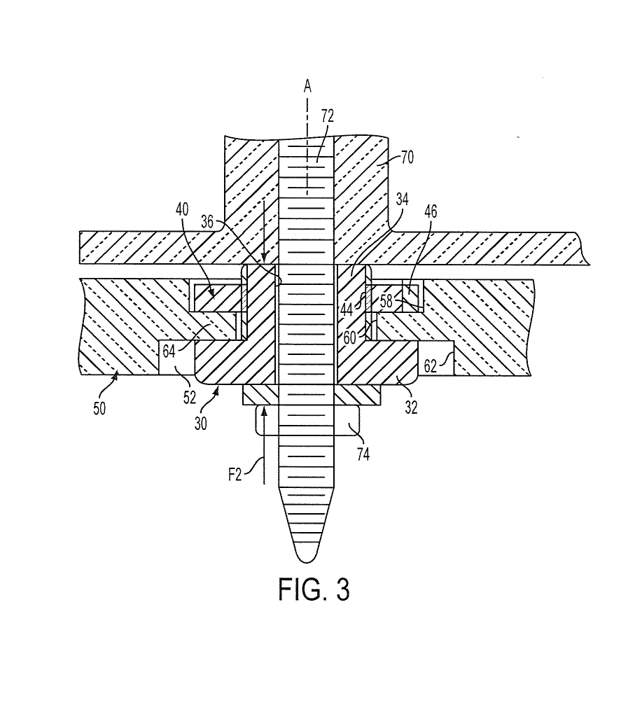

FIG. 3 shows the self-loosening capsule assembly 20 installed in the mounting bracket 50 and assembled together with a vehicle component 70 according to an exemplary embodiment of the present invention. Referring to FIG. 3, a stud 72 extends from the vehicle component 70 and is received through the central bore 36 extending through the capsule 30. A fastening nut 74 is threaded on to a distal end of the stud 72. With the self-loosening capsule assembly 20 and mounting bracket 50 assembled together with the vehicle component 70, the capsule 30 is urged into contact with the vehicle component 70. A second clamping force ‘F2’ is applied to the capsule 30 between the fastening nut 74 and the vehicle component 70.

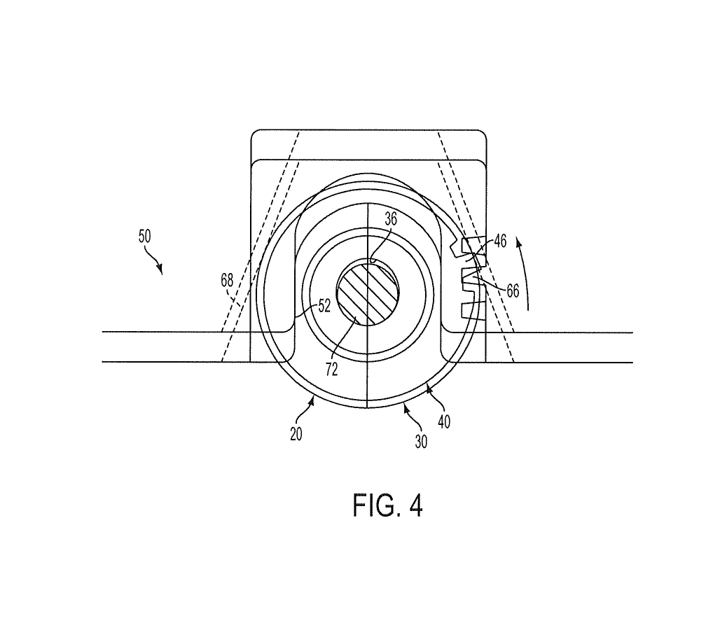

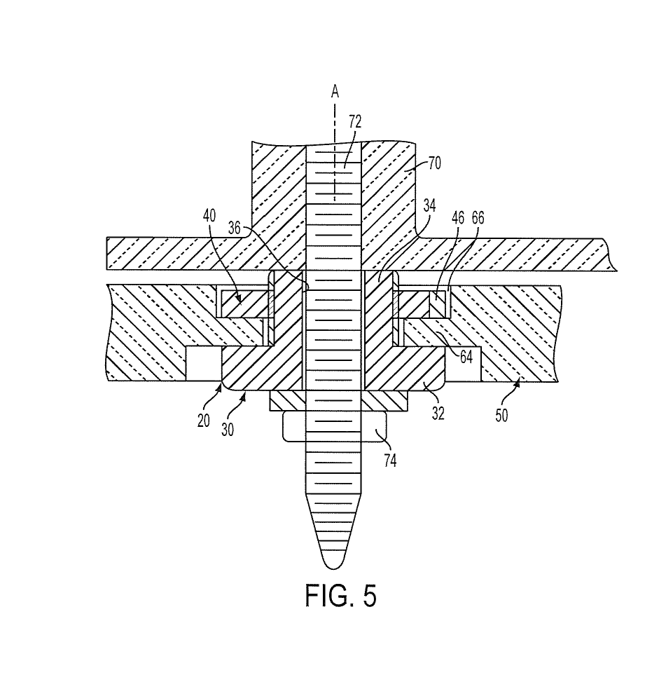

In operation, in the event of a vehicle crash or other impact, the steering column is configured to absorb energy. FIG. 4 is a top view of the self-loosening capsule assembly 20 and mounting bracket 50 assembled with the vehicle 70 during a vehicle crash in accordance with an exemplary embodiment of the present invention. FIG. 5 is a front cross section of the self-loosening capsule assembly 20 and mounting bracket 50 assembled with the vehicle component 70 during a vehicle crash in accordance with an exemplary embodiment of the present invention.

With reference to FIGS. 4 and 5, during a vehicle crash, the steering column, including the mounting bracket 50 is urged forward relative to the vehicle component 70. The self-loosening capsule 20 is maintained in position, or moves by a limited amount, due to the stud 72 extending through the central bore 36. Accordingly, the mounting bracket 50 moves relative to the self-loosening capsule 30. The bracket key mechanism 66 is interfaced with the keying mechanism 46 of the capsule nut 40 to causes the capsule nut 40 to rotate in a loosening direction, i.e., a direction where the capsule nut 40 moves along the body 34 of the capsule such that the first clamping force ‘F1’ is reduced or released during the relative movement. In an exemplary embodiment, the capsule nut 40 is rotated approximately 15° to loosen the self-loosening capsule assembly 20. It is understood, however, that this example is non-limiting, and the self-loosening capsule 20 may be configured to loosen through rotation of the capsule nut 40 through different angles.

In addition, rotation of the capsule nut 40 in the loosening direction negates the second clamping force ‘F2’ applied to the capsule 30. Once the second clamping force ‘F2’ is minimized, the steering column is free to move without resistance, or with reduced resistance, from the self-loosening capsule assembly 20, and thus, may be separated from the vehicle component 70. In an exemplary embodiment, multiple self-loosening capsule assemblies may be used to secure that mounting bracket 50 to the vehicle component 70.

In the exemplary embodiments above, the steering column may break away from the vehicle component 70 in response to an impact from a vehicle crash that causes the mounting bracket 50 to move relative to the stud 72 and self-loosening capsule assembly 20. The configurations described above provide a higher stiffness so that an impact on the steering column may more efficiently be transferred to the self-loosening capsule to cause the steering column to break away from the vehicle component.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A self-loosening capsule assembly for a steering column, the self-loosening capsule assembly comprising:
a capsule configured for installation in a mounting bracket of the steering column, the capsule including a threaded outer surface; and
a capsule nut including a threaded inner surface for threaded coupling to the capsule and movable so as to apply a first clamping force to the mounting bracket, the capsule nut comprising a keying mechanism configured to engage a corresponding keying mechanism on the mounting bracket.

2. The self-loosing capsule assembly of claim 1, wherein the capsule includes a central bore extending therethrough, the central bore configured to receive a stud protruding from an adjacent vehicle component, and a fastening nut is threadably attached to the stud to secure the capsule relative to the adjacent vehicle component.

3. The self-loosening capsule assembly of claim 2, wherein the capsule nut is rotatable in a loosening direction in response to movement of the mounting bracket relative to the capsule nut.

4. The self-loosening capsule assembly of claim 3, wherein the loosening direction is a direction of rotation that causes the capsule nut to release the first clamping force from the mounting bracket.

5. The self-loosening capsule assembly of claim 2, wherein the keying mechanism is positioned on an outer periphery of the capsule nut and includes at least one radially extending projection.

6. The self-loosening capsule assembly of claim 1, wherein the capsule comprises a body and a head, the head having a larger outer diameter than the body.

7. The self-loosening capsule assembly of claim 6, wherein the capsule nut is threadably coupled to the body of the capsule.

8. The self-loosening capsule assembly of claim 1 wherein the capsule and the capsule nut are annular shaped.

9. A steering column comprising:
a mounting bracket configured to be secured to an adjacent vehicle component, the mounting bracket comprising an installation slot, a flange extending within the installation slot and a bracket keying mechanism positioned at a periphery of the installation slot; and
a self-loosening capsule assembly received in the installation slot, the self-loosening capsule assembly comprising:
a capsule comprising a head and a body extending from the head, the body having a threaded outer surface, the head having a larger outer diameter than the body; and
a capsule nut having a threaded inner surface for threaded coupling to the capsule and movable so as to apply a first clamping force to the flange of the mounting bracket between the head and the capsule nut and a keying mechanism configured to interface with the bracket keying mechanism of the mounting bracket.

10. The steering column of claim 9, wherein the self-loosening capsule assembly includes a central bore extending therethrough, the central bore configured to receive a stud extending from an adjacent vehicle component for attachment of the mounting bracket and self-loosening capsule assembly to the adjacent vehicle component.

11. The steering column of claim 10, wherein movement of the mounting bracket relative to the capsule nut causes the capsule nut to rotate in a loosening direction, such that the first clamping force is released from the flange.

12. The steering column of claim 11, wherein the mounting bracket rotates capsule nut via the interface between the bracket keying mechanism and the keying mechanism of the capsule nut.

13. The steering column of claim 12, wherein the keying mechanism of the capsule nut is positioned along an outer periphery of the capsule nut and includes at least one radial projection extending from the capsule nut.

14. The steering column of claim 13, wherein the bracket keying mechanism includes at least one recess configured to receive the at least one radial projection.
